(19) United States
(12) Patent Application Publication
(10) Pub. No.: US 2026/0037199 A1
(43) Pub. Date: Feb. 5, 2026

(54) SYSTEMS AND METHODS FOR COLLECTING PRINTING USAGE STATISTICS

(71) Applicant: CDK GLOBAL, LLC, Hoffman Estates, IL (US)

(72) Inventor: Jim Cox, Saint Helens, OR (US)

(21) Appl. No.: 18/792,468

(22) Filed: Aug. 1, 2024

(51) Int. Cl. G06F 3/12

(52) U.S. Cl. CPC G06F 3/1273; G06F 3/1203; G06F 3/1288

(57) ABSTRACT

Methods and systems for print statistics collection are disclosed. An example method includes: recording a number of printed documents for each form type at first predetermined intervals of time by each client system of a plurality of client systems; and recording a number of received print requests at second predetermined intervals of time by each client system of the plurality of client systems.

### BACKGROUND

To compute printing statistics across systems, analytic platforms using standard internet protocols have been used to gather analytics. In order to gather such analytics, analytic platforms (e.g., Google Analytics, Amplitude, etc.) may collect data, such as each printing related event to be transmitted from a source device (e.g., a terminal, a server device) that initiates the printing related event. Conventionally, collecting printing statistics involves transmitting (e.g., downloading) all time stamps of print requests and/or printing executions to the analytic platforms to be analyzed. This transmission tends to consume time, communication bandwidth, and memory across the systems.

### BRIEF DESCRIPTION OF THE DRAWINGS

FIG. 1 is an example flowchart of a method of collecting printing usage statistics in accordance with examples described herein.

FIG. 2 is a schematic diagram of a system including a server with a print statistics manager in accordance with examples described herein.

FIG. 3 is a schematic illustration of a server and a client system that may be used to implement systems and methods in accordance with examples described herein.

FIG. 4A is a schematic illustration of a virtual server that may be used to implement the server on a cloud in accordance with examples described herein.

FIG. 4B is a schematic illustration of servers on a cloud that may be used to implement a database of the virtual server in accordance with examples described herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Certain details are set forth herein to provide an understanding of described embodiments of technology. However, other examples may be practiced without various of these particular details. In some instances, well-known computer system components, artificial intelligence (AI) techniques, online computer resource analytics particulars, circuits, control signals, timing protocols, and/or software operations have not been shown in detail in order to avoid unnecessarily obscuring the described embodiments. Other embodiments may be utilized, and other changes may be made, without departing from the spirit or scope of the claims.

The present disclosure provides various embodiments of collecting printing usage statistics from each of client systems within a system, such as a central server. On each of the client systems (e.g., legacy systems, such as dealer management systems (DMSs)), several types of printing records may be created and updated per a specified time period (e.g., per day) as printing access requests are received from a user via a terminal (e.g., a terminal located in a dealer store). In some examples, types of printing records may include a record about a number of printed documents for each form type at first predetermined intervals of time by each client system. In some examples, such a record about a number of printed documents for each form type may also be created and updated for each account (e.g., a software account, a part account, a service account, or a vehicle account). In some examples, printing each document of the documents is performed via either an old system or a new system, and whether printing of each document performed via the old system or the new system may be recorded. Such record may enable tracking progress of migration from the old system to the new system.

In some examples, types of printing records may include a record about a number of received print requests at second predetermined intervals (e.g., per second) of time by each client system. This record may contain a time grid (e.g., an hour/second grid, up to 24 attributes each having up to 3,600 values); however, a grid size, a number of attributes, and a number of values are not limited to these examples. Each element in the grid may store a count of print requests made during that time grid. Based on the record, a peak time and a number of print requests at the peak time may be computed.

In some examples, the recorded numbers of printed documents and the recorded numbers of print requests may be collected from each client system periodically (e.g., at third predetermined intervals, typically longer than a second or an hour). Records for each type from client systems may be consolidated into a master record of each type. For example, a master record about numbers of printed documents for each form type at first predetermined intervals of time of all the client systems in the system and a master record about numbers of received print requests at second predetermined intervals (e.g., per second) of time of all the client systems in the system may be created at fourth predetermined intervals (e.g., per day), thus cumulative numbers of printed documents by form type and print requests per second at fourth predetermined intervals may be created.

Using the collection of printing usage statistics disclosed herein, time and a communication bandwidth needed for communications with external analytic platforms may be reduced or eliminated, and printing usage statistics may be collected within the system internally in a time and cost-effective manner.

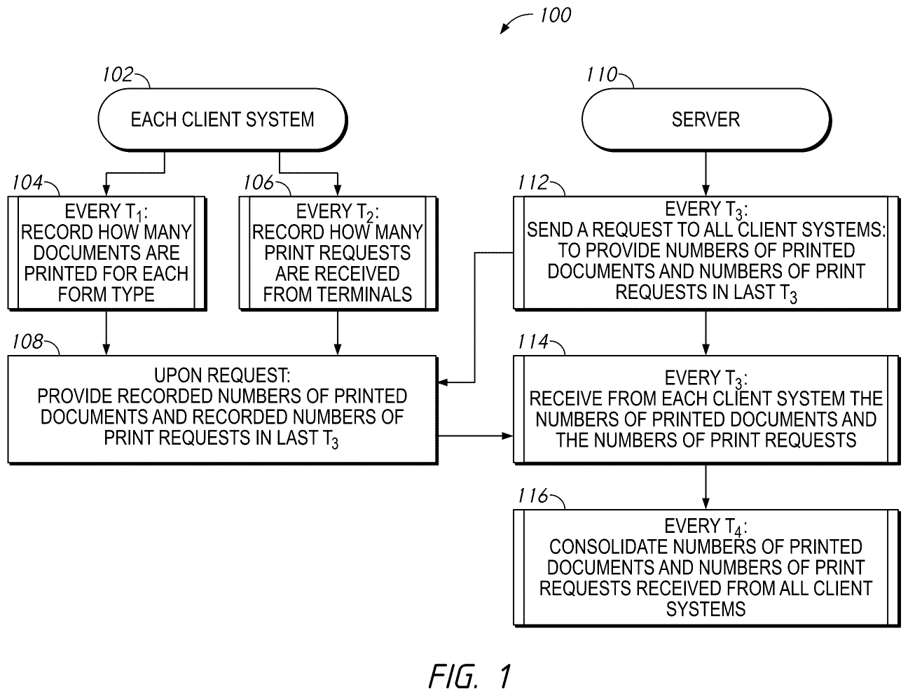

FIG. 1 illustrates an example flowchart of a method 100 of collecting printing usage statistics in accordance with examples described herein. Although the example method 100 depicts a particular sequence of operations, the sequence may be altered without departing from the scope of the present disclosure. For example, some of the operations depicted may be performed in parallel or in a different sequence that does not materially affect the function of the method 100.

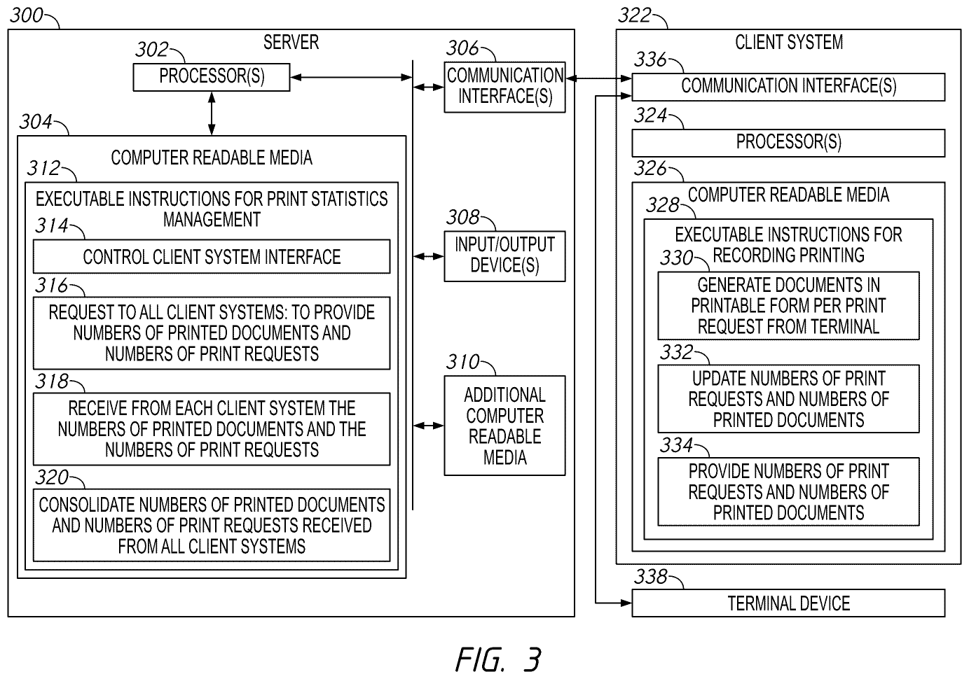

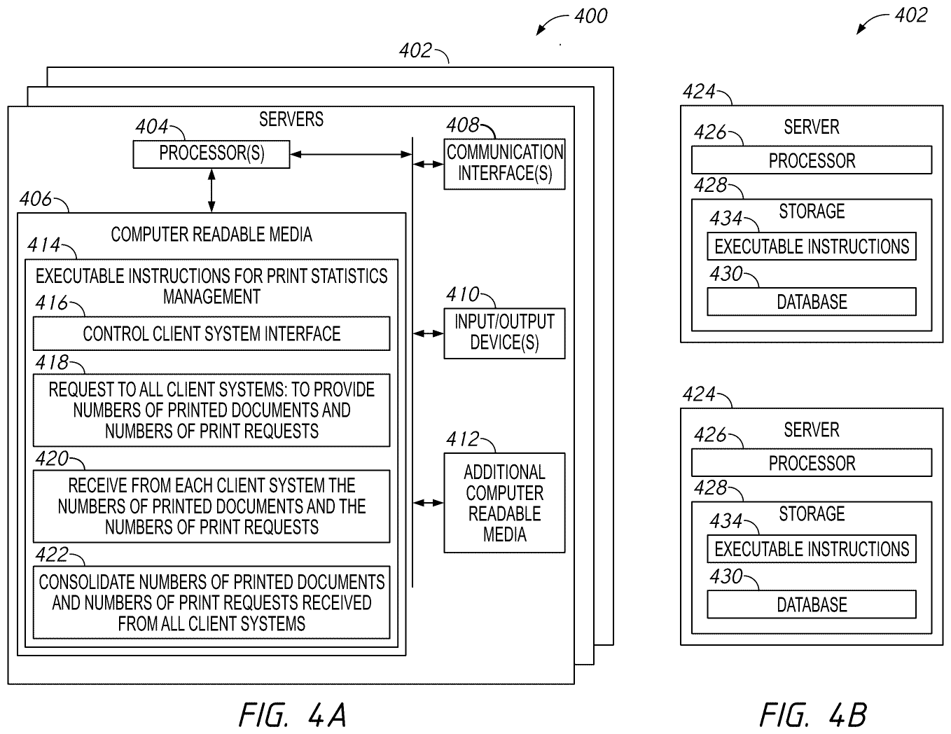

According to some examples, the method 100 includes operations 102 by each client system of a plurality of client systems and operations 110 by a server. Each client system and the server may communicate to one another to perform the operations 102 and the operations 110, respectively. In some examples, the operations 110 may be performed by one or more processor(s) 302 of a server 300 of FIG. 3. In some examples, the operations 110 may be performed by one or more processor(s) 404 of servers 402 performing as a virtual server 400 of FIG. 4A. In some examples, the operations 102 may be performed by one or more processor(s) 324 of a client system 322 of FIG. 3. In other examples, different components of an example device or system that implements the method 100 may perform operations at substantially the same time or in a specific sequence.

According to some examples, the operations 102 of each client system includes recording how many documents are printed for each form type at first predetermined intervals of time (at every T₁) by each client system of the plurality of client systems at operation 104. In some examples, documents may be described in a form specific language, such as the printer command language (PCL). In some examples, recording how many documents are printed for each form type may also be created and updated for each account (e.g., a software account, a part account, a service account, or a vehicle account). In some examples, each of the plurality of client systems may be preexisting legacy systems, such as DMSs in a context of the automotive industry. In some examples, printing each document of the documents is performed via either an old system such as POH or a new system such as DCM and whether printing of each document performed via the old system or the new system may be recorded. Such record may enable tracking progress of migration from the old system to the new system.

According to some examples, the operations 102 of each client system includes recording how many print requests are received from terminals at second predetermined intervals of time (every T₂) by each client system of the plurality of client systems at operation 106. In some examples, the second predetermined interval may be a second. A number of print requests may be recorded in a time grid (e.g., an hour/second grid, up to 24 attributes each having up to 3,600 values); however, a grid size, a number of attributes, and a number of values are not limited to these examples. Each element in the grid may store a count of print requests made during that time grid. Based on the record, a peak time and a number of print requests at the peak time may be computed.

In some examples, the first predetermined interval of time and the second predetermined interval of time may be the same. In some examples, the first predetermined interval of time and the second predetermined interval of time may be different. In some examples, the operations 104 and the operations 106 may be performed in parallel.

According to some examples, the operations 110 of the server may include sending a request to all client systems to provide numbers of printed documents and numbers of print requests periodically, for example, at third predetermined intervals (every T₃) at operation 112 and receiving from each client system the numbers of printed documents and the numbers of print requests provided periodically, for example, at third predetermined intervals (every T₃) at operation 114. In some examples, the third predetermined interval may typically be longer than a second or an hour.

In response to the requests sent in the operation 112, each client system may provide recorded numbers of printed documents and recorded numbers of print requests in the last third predetermined interval (T₃) in the operation 108. The server may receive from each client system the numbers of printed documents and the numbers of print requests provided at the operation 114. Thus, the recorded numbers of printed documents and the recorded numbers of print requests may be collected from each client system periodically (e.g., at third predetermined intervals). After receiving the numbers of printed documents and the numbers of print requests provided at the operation 114, the server may perform the operation 112 after another third predetermined interval.

According to some examples, the operations 110 of the server may include consolidating numbers of printed documents and numbers of print requests received from all client systems at fourth predetermined intervals (every T₄) at operation 116. Records for each type from client systems may be consolidated into a master record of each type. In some examples, the fourth predetermined interval may be equal to or longer than the third predetermined interval, such as a day. For example, a master record about numbers of printed documents for each form type at first predetermined intervals of time of all the client systems in the system and a master record about numbers of received print requests at second predetermined intervals (e.g., per second) of time of all the client systems in the system may be created at fourth predetermined intervals (e.g., per day). Cumulative numbers of printed documents by form type and print requests per second at fourth predetermined intervals may be created.

Thus, printing statistics may be obtained by a server and client systems within a system without relying on external analytic platforms.

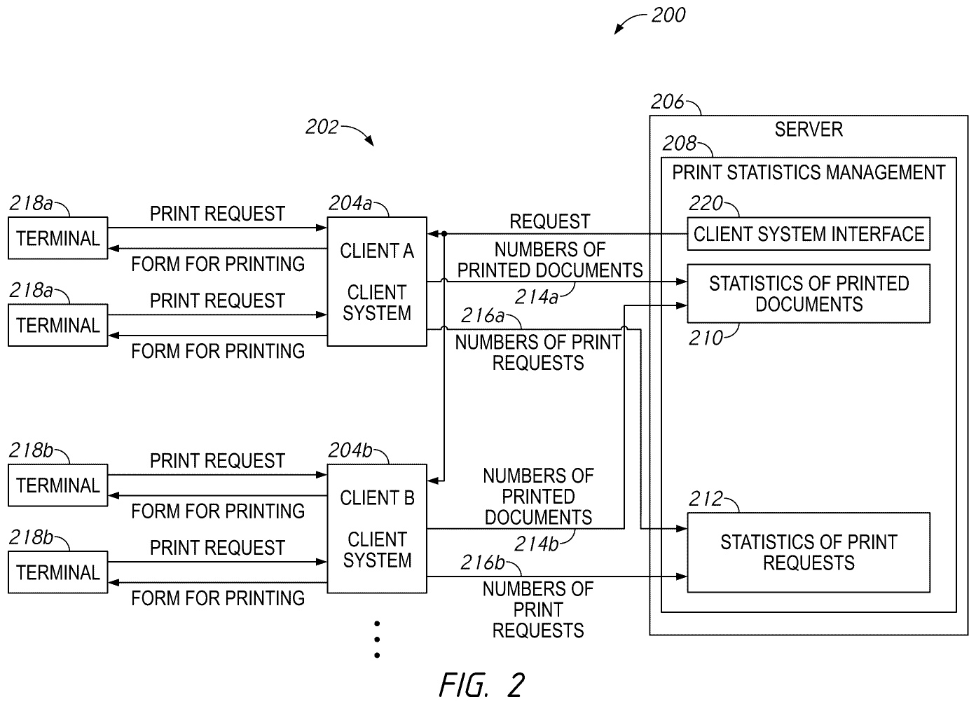

FIG. 2 illustrates a schematic diagram of a system 200 including a server 206 with a print statistics manager 208 in accordance with examples described herein. The system 200 may further include client systems 202 and one or more terminals configured to couple to one of the client systems 202. In some examples, the system 200 may include one or more client systems 202 for corresponding with one or more clients, where each client system may be a client system 322 of FIG. 3. In some examples, the one or more client systems 202 may include DMSs for a plurality of dealers included in the system 200. For example, the one or more client systems 202 may include a client system 204a for Client A (e.g., Dealer A) and a client system 204b for Client B (e.g., Dealer B). In some examples, the client system 204a may communicate with terminals 218a in one or more stores of Dealer A, and the client system 204b may communicate with terminals 218b in one or more stores of Dealer B.

In some examples, the server 206 may be a computing device. In some examples, the server 206 may be a server 300 of FIG. 3. In some examples, the server 206 may be a virtual server that may include a plurality of computing devices to implement a virtual server 400 of FIG. 4A. The server 206 may perform as a central server of the system 200. In some examples, the server 206 may include a print statistics manager 208. In some examples, the print statistics manager 208 may include a client system interface 220. The print statistics manager 208 may collect and store statistics of printed documents 210 and statistics of print requests 212.

In some examples, each of the one or more client systems 202 may perform the operations 102. In some examples, the client system 204a may receive a print request from one of the terminals 218a, and in response, the client system 204a may provide a document, such as a form for printing and allow the terminal 218a to print out the document. The client system 204a may store a record of the print requests and a record of providing the documents for printing. The client system 204a may further create and/or update numbers of print requests and numbers of printed documents periodically, as described herein as the operations 104 and 106. Similarly, the client system 204b may receive a print request from one of the terminals 218b, and in response, the client system 204b may provide a document, such as a form for printing and allow the terminal 218b to print out the document. The client system 204b may store a record of the print requests and a record of providing the documents for printing. The client system 204b may further create and/or update numbers of print requests and numbers of printed documents periodically, as described herein as the operations 104 and 106.

In some examples, the print statistics manager 208 of the server 206 may perform the operations 110 to obtain statistics. The print statistics manager 208 may use the client system interface 220 to perform the operation 112, sending a request to all client systems 202 to provide numbers of printed documents and numbers of print requests periodically, for example, at third predetermined intervals (every T₃). In some examples, all the requests may be provided to all the client systems 202 at the same time. In some examples, the requests may be provided to the client systems 202 at different times to reduce communication processing loads at a time. For example, a request to the client system 204a to provide numbers of printed documents 214a and a request to the client system 204a to provide numbers of print requests 216a may be sent at different timings. For example, a request to the client system 204a to provide numbers of printed documents 214a and a request to the client system 204b to provide numbers of printed documents 214b may be sent at different times.

In response to the requests sent in the operation 112, each of the client systems 202 may provide recorded numbers of printed documents and recorded numbers of print requests in the last third predetermined interval (T₃) in the operation 108. For example, the client system 204a may provide numbers of printed documents 214a and numbers of print requests 216a at third predetermined intervals (every T₃), and the client system 204b may provide numbers of printed documents 214b and numbers of print requests 216b at the third predetermined intervals (every T₃). The server 206 may receive from each client system the numbers of printed documents and the numbers of print requests provided at the operation 114. In some examples, the server 206 may receive numbers of printed documents from the client systems 202, including the numbers of printed documents 214a and the numbers of printed documents 214b. In some examples, the server 206 may receive numbers of printed documents from the client systems 202, including the numbers of print requests 216a and the numbers of print requests 216b. Thus, the recorded numbers of printed documents and the recorded numbers of print requests may be collected from each client system periodically (e.g., at third predetermined intervals). After receiving the numbers of printed documents and the numbers of print requests provided at the operation 114, the server may perform the operation 112 after another third predetermined interval.

According to some examples, the server 206 may consolidate numbers of printed documents and numbers of print requests received from all client systems at fourth predetermined intervals (every T₄) at operation 116. Records for each type from client systems may be consolidated into a master record of each type. In some examples, the fourth predetermined interval may be longer than the third predetermined interval, such as a day. For example, a master record about numbers of printed documents for each form type at first predetermined intervals of time of all the client systems in the system may be used to compute statistics of printed documents 210 and a master record about numbers of received print requests at second predetermined intervals (e.g., per second) of time of all the client systems in the system may be used to compute statistics of print requests 212. This consolidation of the collected data and/or statistics based on the collected data may be performed at fourth predetermined intervals (e.g., per day), and cumulative numbers of printed documents by form type and print requests per second at fourth predetermined intervals may be created.

FIG. 3 is a schematic illustration of a server 300 and a client system 322 that may be used to implement systems and methods in accordance with examples described herein. The server 300 includes one or more processor(s) 302, and one or more computer readable media 304 that may store executable instructions for print statistics management 312. The server 300 may further include an input/output device(s) 308, communication interface(s) 306, and/or one or more additional computer readable media 310. The executable instructions for print statistics management 312 may include executable instructions 314 for executing one or more control client system interfaces, executable instructions 316 for requesting client systems (e.g., all client systems, including the client system 322) to provide numbers of printed documents and numbers of print requests, executable instructions 318 for receiving from each client system the numbers of printed documents and the numbers of print requests provided responsive to the request, and executable instructions 320 for consolidating numbers of printed documents and numbers of print requests received from all client systems.

The server 300 may be implemented, for example, using one or more computers, servers, smart phones, smart devices, tablets, and/or appliances. The server 300 may be coupled to and/or in communication with a source or storage of documents to be printed, such as the client system 322. The server 300 may perform the operations 110. In some embodiments, the server 300 may be physically coupled to a source or storage of documents to be printed, such as the client system 322. In other embodiments, the computer system may not be physically coupled to a source or storage of data, such as the client system 322, but may be in communication with a source or storage of the documents, such as the client system 322.

Computer systems, such as the server 300, may include one or more processor(s) 302. Any kind and/or number of processors may be present, including one or more central processing unit(s) (CPUs), graphics processing units (GPUs), other computer processors, mobile processors, digital signal processors (DSPs), field programmable gate arrays (FPGAs), application specific integrated circuits (ASICs), microprocessors, computer chips, and/or processing units configured to execute machine-language instructions and process data, such as the executable instructions to perform operations 110.

Computer systems, such as the server 300, may further include computer readable media 304. Any type or kind of media may be present, including memory and/or storage. Examples include read only memory (ROM), random access memory (RAM), solid state drive (SSD), secure digital card (SD card), hard drive, network-attached storage, etc. Computer systems, such as the server 300 of FIG. 3, may further include additional computer readable media 310. While each single box is depicted as computer readable media in FIG. 3, any number of memory and/or storage devices may be present. The computer readable media, such as the computer readable media 304 and/or the additional computer readable media 310 may be in communication with (e.g., electrically connected to) the processor(s) 302.

The server 300 may include additional components, not all of which are necessarily depicted in FIG. 3. Examples of additional components may include the one or more communication interface(s) 306. In some examples, the one or more communication interface(s) 306 may include wireless communication interfaces such as a wireless network (e.g., IEEE 802.11 as known as Wi-Fi), Bluetooth, network interface, cellular interface, wired communication interfaces such as serial buses (e.g., universal serial bus), or parallel data interface, and/or other communications interface. The communication interface(s) 306 may be used to send one or more requests to the one or more client systems, including the client system 322, and receive the numbers of printed documents and the numbers of print requests from the one or more client systems. The server 300 may include one or more input and/or output devices 308 including, but not limited to, one or more printers, touchscreens, mice, keyboards, and/or cameras. The printer may be operated by a user of the server 300, the client system 322 or a terminal device 338 to print the form(s). The server 300 may include and/or be in communication with additional computer readable media 310 that may provide temporary data to be used during processing, or permanent data to be stored for record or presented to a user.

The executable instructions for print statistics management 312 when executed by the server 300, cause the server 300 to perform the executable instructions 314, 316, 318 and 320 by the processor(s) 302. The processor(s) 302 may perform the executable instructions 314 to execute one or more control client system interfaces that controls the communication interface(s) 306, that is used by the executable instructions 316 for sending one or more print requests to the communication interface(s) 306 and executable instructions 318 for receiving the numbers of printed documents and the numbers of print requests. In some examples, the processor(s) 302 may perform requesting client systems (e.g., all client systems, including the client system 322) to provide numbers of printed documents and numbers of print requests at every T₃, and receiving from each client system the numbers of printed documents and the numbers of print requests provided responsive to the request. This is repeated at every T₃, and the processor(s) 302 may perform executable instructions 320 for consolidating numbers of printed documents and numbers of print requests received from all client systems at every T₄.

In some examples, the server 300 may store the numbers of printed documents and the numbers of print requests received from each client system 322 in the additional computer readable media 310. In some examples, the numbers of printed documents and the numbers of print requests from each client system, such as the client system 322 may be stored in the additional computer readable media 310 at different timings. In some examples, the numbers of printed documents and the numbers of print requests from each client system, such as the client system 322, may be received together at the communication interface(s) 306 and stored in the one or more additional computer readable media 310.

In some examples, the additional computer readable media 310 may include a database 340. The processor(s) 302 of the server 300 may manage access to the database 340. The recorded numbers of printed documents and the recorded numbers of print requests from the plurality of client systems may be received by a computing device of an old system, such as the server 300, and the processor(s) 302 may store the recorded numbers of printed documents and the recorded numbers of print requests on the database 340.

In some examples, the client system 322 may be one of the client systems 202 of FIG. 2. The client system 322 includes one or more processor(s) 324, and one or more computer readable media 326 that may store executable instructions for recording printing 328. The client system 322 may further include communication interface(s) 336.

The executable instructions for recording printing 328 may include executable instructions 330 for generating documents in printable form per a print request from terminal device 338, executable instructions 332 for updating numbers of print requests and numbers of printed documents, and executable instructions 334 for providing the numbers of print requests and the numbers of printed documents.

The client system 322 may be implemented, for example, using one or more computers, servers, smart phones, smart devices, tablets, and/or appliances. The client system 322 may be coupled to and/or in communication with one or more terminal devices, such as the terminal device 338 that may provide printing requests.

Computer systems, such as the client system 322, may include the one or more processor(s) 324. Any kind and/or number of processors may be present, including one or more central processing unit(s) (CPUs), graphics processing units (GPUs), other computer processors, mobile processors, digital signal processors (DSPs), field programmable gate arrays (FPGAs), application specific integrated circuits (ASICs), microprocessors, computer chips, and/or processing units configured to execute machine-language instructions and process data, such as the executable instructions to perform operations 102.

Computer systems, such as the client system 322, may further include the one or more computer readable media 326. Any type or kind of media may be present, including memory and/or storage. Examples include read only memory (ROM), random access memory (RAM), solid state drive (SSD), secure digital card (SD card), hard drive, network-attached storage, etc.

In some examples, the one or more communication interface(s) 336 may include wireless communication interfaces such as a Wi-Fi, Bluetooth, network interface, cellular interface, wired communication interfaces such as serial buses (e.g., universal serial bus), or parallel data interface, and/or other communications interface. The communication interface(s) 336 may be used to receive one or more requests and send the numbers of printed documents and the numbers of print requests. The client system 322 may include additional components, not all of which are necessarily depicted in FIG. 3.

The processor(s) 324 may perform the executable instructions for recording printing 328. In some examples, upon a print request from the terminal device 338 received at the communication interface(s) 336, the processor(s) 324 may perform the executable instructions 330 for generating documents in printable form and the client system 322 may provide the generated documents through the communication interface(s) 336 to the terminal device 338. In some examples, upon the print request from the terminal device 338, the processor(s) 324 may perform executable instructions 332 for updating numbers of print requests. In some examples, the processor(s) 324 or the computer readable media 326 may include a counter that may store a number of print requests and the processor(s) 324 may add one to the number of print requests per a receipt of the print request from the terminal device 338. In some examples, upon generating documents in printable form, the processor(s) 324 may perform executable instructions 332 for updating numbers of printed documents. In some examples, the processor(s) 324 or the computer readable media 326 may include another counter that may store a number of printed documents and the processor(s) 324 may add one to the number of printed documents per generation of a document in printable form.

Upon a request to provide the numbers of print requests and the numbers of printed documents, the processor(s) 324 may perform executable instructions 334 for providing the numbers of print requests and the numbers of printed documents from the communication interface(s) 336. In some examples, the processor(s) 324 may subtract previous numbers of print requests and previous numbers of printed documents from current numbers of print requests and current numbers of printed documents, and provide the numbers of print requests and the numbers of printed documents in a last time period (e.g., T₃) since a previous request. In some examples, the processor(s) 324 may reset the counters upon providing the current numbers of print requests and the current numbers of printed documents, thus the processor(s) 324 may provide next numbers of print requests and next numbers of printed documents without computing subtraction upon a next request.

FIG. 4A is a schematic illustration of a virtual server 400 that may be used to implement the server on a cloud in accordance with examples described herein. Although the example virtual server 400 depicts a particular sequence of operations, the sequence may be altered without departing from the scope of the present disclosure. For example, some of the operations depicted may be performed in parallel or in a different sequence that does not materially affect the function of the virtual server 400. In other examples, different components of an example device or system that implements the virtual server 400 may perform functions at substantially the same time or in a specific sequence.

In some examples, the virtual server 400 may be implemented using servers 402 that may be physical servers. In some examples, the virtual server 400 may include one or more virtual servers. In some examples, each of the servers 402 may include one or more processor(s) 404 and one or more computer readable media 406. In some examples, each of the servers 402 may further include an input/output device(s) 410, communication interface(s) 408, and/or one or more additional computer readable media 412. In some examples, the computer readable media 406 of the servers 402 may store executable instructions for print statistics management 414. In some examples, the executable instructions for print statistics management 414 may be stored in one of the servers 402. In some examples, the executable instructions for print statistics management 414 may be stored in one or more servers of the servers 402. The executable instructions for print statistics management 414 may include executable instructions 416 for executing one or more control client system interface, executable instructions 418 for requesting client systems to provide numbers of printed documents and numbers of print requests, executable instructions 420 for receiving from each client system the numbers of printed documents and the numbers of print requests provided responsive to the request, and executable instructions 422 for consolidating numbers of printed documents and numbers of print requests received from all client systems. Any of the servers 402 may be implemented, for example, using one or more computers, servers, smart phones, smart devices, tablets, and/or appliances. The servers 402 may be coupled to and/or in communication with a source or storage of documents to be printed, such as one or more client systems, such as the client systems 202 of FIG. 2.

The virtual server 400 may perform the operations 110. In some embodiments, any of the servers 402 may be physically coupled to a source or storage of documents to be printed, such as the client systems 202 of FIG. 2. In other embodiments, the computer system may not be physically coupled to a source or storage of data, such as the client systems 202 of FIG. 2, but may be in communication with a source or storage of documents, such as the client systems 202 of FIG. 2.

Computer systems, such as the servers 402, may include one or more processor(s) 404. Any kind and/or number of processors may be present, including one or more central processing unit(s) (CPUs), graphics processing units (GPUs), other computer processors, mobile processors, digital signal processors (DSPs), field programmable gate arrays (FPGAs), application specific integrated circuits (ASICs), microprocessors, computer chips, and/or processing units configured to execute machine-language instructions and process data, such as the executable instructions to perform operations 110.

Computer systems, such as the servers 402, may further include one or more computer readable media 406. Any type or kind of media may be present, including memory and/or storage. Examples include read only memory (ROM), random access memory (RAM), solid state drive (SSD), secure digital card (SD card), hard drive, network-attached storage, etc. Computer systems, such as the servers 402, may further include additional computer readable media 412. While each single box is depicted as computer readable media in FIG. 4A, any number of memory and/or storage devices may be present. The computer readable media, such as the computer readable media 406 and/or the additional computer readable media 412, may be in communication with (e.g., electrically connected to) the processor(s) 404.

Computer systems, such as the servers 402, may further include the one or more communication interface(s) 408. In some examples, the one or more communication interface(s) 306 may include wireless communication interfaces such as a Wi-Fi, Bluetooth, network interface, cellular interface, wired communication interfaces such as serial buses (e.g., universal serial bus), or parallel data interfaces, and/or other communications interfaces. The communication interface(s) 408 may be used to send one or more requests to one or more client systems, such as the client systems 202 of FIG. 2, and receive the numbers of printed documents and the numbers of print requests.

Each of the servers 402 may include additional components, not all of which are necessarily depicted in FIG. 4A. Each of the servers 402 may include one or more input and/or output device(s) 410 including, but not limited to, one or more printers, touchscreens, mice, keyboards, and/or cameras. The printer may be operated by a user of the corresponding server 402 and/or a client system coupled to or in communication with the server 402 to print the documents. The servers 402 may include and/or be in communication with additional computer readable media 412 that may provide temporary data to be used during processing, or permanent data to be stored for record or presented to a user.

The processor(s) 404 may perform the executable instructions 416 to execute one or more control client system interfaces that controls the communication interface(s) 408 that is used by the executable instructions 418 for sending one or more requests to the communication interface(s) 408 and executable instructions 420 for receiving the numbers of printed documents and the numbers of print requests at the communication interface(s) 408. In some examples, the processor(s) 404 may perform requesting client systems (e.g., all client systems, including the client systems 202) to provide numbers of printed documents and numbers of print requests at every T₃, and receiving from each client system the numbers of printed documents and the numbers of print requests provided responsive to the request. This is repeated at every T₃, and the processor(s) 404 may perform executable instructions 422 for consolidating numbers of printed documents and numbers of print requests received from all client systems at every T₄.

FIG. 4B is a schematic illustration of servers 402 on a cloud that may be used to implement a database of the virtual server 400 in accordance with examples described herein. The servers 402 may include servers 424 to implement a cloud. Each server 424 may include one or more processor(s) 426 and a storage 428. In some examples, the storage 428 may include one or more computer readable media 406. The storage 428 may further store executable instructions 432 and data including data in a format of a database 430.

In some examples, the numbers of printed documents and the numbers of print requests received from each client system may be stored in the database 430 implemented on one or more servers 424 of the servers 402. In some examples, the numbers of printed documents and the numbers of print requests from each client system, such as the client systems 202 may be stored in the database 430 at different timings. In some examples, the numbers of printed documents and the numbers of print requests from each client system, such as a client system of the client systems 202, may be received together at the communication interface(s) 408 and stored in the database 430 implemented on one or more servers 424 of the servers 402. The processor(s) 426 of each server 424 may perform the executable instructions 432 to manage the database 430 on the cloud, such as managing local access of the database 430.

As described herein, a server for managing printing statistics may be implemented on a legacy system that may communicate with client systems, or on a system on a cloud, including physical servers that may communicate with client systems.

From the foregoing it will be appreciated that, although specific embodiments have been described herein for purposes of illustration, various modifications may be made while remaining within the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signals or communications may be provided directly to and/or received directly from the recited components without intervening components, but also may be provided to and/or received from the certain components through intervening components.

What is claimed is:

1. A method of collecting printing statistics comprising:
recording a number of printed documents for each form type at first predetermined intervals of time by each client system of a plurality of client systems; and
recording a number of received print requests at second predetermined intervals of time by each client system of the plurality of client systems.

2. The method of claim 1, further comprising computing a peak time and a number of print requests at the peak time based on the recorded number of received print requests at the second predetermined intervals of time.

3. The method of claim 1, further comprising receiving recorded numbers of printed documents and recorded numbers of print requests at third predetermined intervals of time from each client system of the plurality of client systems,
wherein each third predetermined interval of time is longer than any of each first predetermined interval of time and each second predetermined interval of time.

4. The method of claim 3, wherein said receiving comprises:
sending a request from a server to each client system of the plurality of client systems to provide the recorded numbers of printed documents and the recorded numbers of print requests at the third predetermined intervals of time; and
receiving the recorded numbers of printed documents and the recorded numbers of print requests by the server at the third predetermined intervals of time.

5. The method of claim 3, further comprising consolidating the received recorded numbers of printed documents and the received recorded numbers of print requests from the plurality of client systems at fourth predetermined intervals of time,
wherein each fourth predetermined interval of time is equal to or longer than each third predetermined interval of time.

6. The method of claim 1, wherein said recording, the number of printed documents is further performed for each account of one or more accounts at first predetermined intervals of time by each client system of the plurality of client systems.

7. The method of claim 6, wherein the one or more accounts comprises at least one of a software account, a part account, a service account, or a vehicle account.

8. The method of claim 1, further comprising:
printing each document of the documents provided by either a first system or a second system; and
recording the number of printed documents for each system of the first system or the second system that provided the printed documents.

9. The method of claim 8, further comprising:
receiving the recorded numbers of printed documents and the recorded numbers of print requests from the plurality of client systems by a computing device of the first system;
storing the recorded numbers of printed documents and the recorded numbers of print requests on a database in the computing device; and
managing the database by the computing device.

10. The method of claim 8, wherein the second system comprises the server that is a virtual server implemented on a cloud including a plurality of physical servers, the method further comprising:
receiving the recorded numbers of printed documents and recorded numbers of print requests from the plurality of client systems by a database stored across one or more physical servers of the plurality of physical servers on the cloud; and
managing the database on the cloud.

11. A computer readable storage medium including instructions that, when executed by a server, cause the server to:
receive, at third predetermined intervals of time, a number of printed documents for each form type recorded by each client system of a plurality of client systems recorded at first predetermined intervals of time and a number of received print requests recorded by each client system of the plurality of client systems recorded at second predetermined intervals of time, each third predetermined interval of time is longer than any of each first predetermined interval of time and each second predetermined interval of time.

12. The computer-readable storage medium of claim 11, wherein the instructions further configure the server to compute a peak time and a number of print requests at the peak time based on the recorded number of received print requests at the second predetermined intervals of time.

13. The computer-readable storage medium of claim 11, wherein the instructions further configure the server to send a request from a server to each client system of the plurality of client systems to provide the recorded numbers of printed documents and the recorded numbers of print requests at the third predetermined intervals of time.

14. The computer-readable storage medium of claim 11, wherein the instructions further configure the server to consolidate the received recorded numbers of printed documents and recorded numbers of print requests from the plurality of client systems at fourth predetermined intervals of time, and
wherein each fourth predetermined interval of time is equal to or longer than each third predetermined interval of time.

15. The computer-readable storage medium of claim 11, wherein the instructions further configure the server to record the number of printed documents for each account of one or more accounts.

16. The computer-readable storage medium of claim 15, wherein the one or more accounts comprises at least one of a software account, a part account, a service account, or a vehicle account.

17. The computer-readable storage medium of claim 11, wherein the instructions further configure the server to:
print each document of the documents provided by either a first system or a second system; and
record the number of printed documents for each system of the first system or the second system that provided the printed documents.

18. The computer-readable storage medium of claim 17, wherein the first system comprises a computing device comprising a database, and
wherein the instructions further configure the server to:
receive the numbers of printed documents and the numbers of print requests from the plurality of client systems recorded by the computing device;
store the recorded numbers of printed documents and the recorded numbers of print requests on the database; and
manage the database by the computing device.

19. The computer-readable storage medium of claim 17, wherein the second system comprises the server that is a virtual server implemented on a cloud including a plurality of physical servers, the instructions further configure the server to:
receive the recorded numbers of printed documents and recorded numbers of print requests from the plurality of client systems by a database stored across one or more physical servers of the plurality of physical servers on the cloud; and
manage the database on the cloud.

20. A server comprising:
one or more processors;
a computer-readable storage medium including instructions that, when executed by the one or more processors, cause the server to:
receive, at third predetermined intervals of time, a number of printed documents for each form type recorded by each client system of a plurality of client systems recorded at first predetermined intervals of time and a number of received print requests recorded by each client system of the plurality of client systems recorded at second predetermined intervals of time, each third predetermined interval of time is longer than any of each first predetermined interval of time and each second predetermined interval of time.

21. The server of claim 20, wherein the instructions further configure the server to compute a peak time and a number of print requests at the peak time based on the recorded number of received print requests at the second predetermined intervals of time.

22. The server of claim 20, wherein the instructions further configure the server to send a request from a server to each client system of the plurality of client systems to provide the recorded numbers of printed documents and the recorded numbers of print requests at the third predetermined intervals of time.

23. The server of claim 20, wherein the instructions further configure the server to consolidate the received recorded numbers of printed documents and recorded numbers of print requests from the plurality of client systems at fourth predetermined intervals of time, and
wherein each fourth predetermined interval of time is equal to or longer than each third predetermined interval of time.

24. The server of claim 20, wherein the instructions further configure the server to record the number of printed documents for each account of one or more accounts.

25. The server of claim 24, wherein the one or more accounts comprises at least one of a software account, a part account, a service account, or a vehicle account.

26. The server of claim 20, wherein the instructions further configure the server to:
print each document of the documents provided by either a first system or a second system; and
record the number of printed documents for each system of the first system or the second system that provided the printed documents.

27. The server of claim 20, wherein the first system comprises a computing device comprising a database, and
wherein the instructions further configure the server to:
receive the numbers of printed documents and the numbers of print requests from the plurality of client systems recorded by the computing device;
store the recorded numbers of printed documents and the recorded numbers of print requests on the database; and
manage the database by the computing device.

28. The server of claim 20, wherein the second system comprises the server that is a virtual server implemented on a cloud including a plurality of physical servers, the instructions further configure the server to:
receive the recorded numbers of printed documents and recorded numbers of print requests from the plurality of client systems by a database stored across one or more physical servers of the plurality of physical servers on the cloud; and
manage the database on the cloud.
